(19) United States
(12) Patent Application Publication
(10) Pub. No.: US 2017/0249845 A1
(43) Pub. Date: Aug. 31, 2017

(54) DRIVING ASSISTANCE SYSTEM OF MOTOR VEHICLES

(71) Applicant: B-LAB S.R.L., Milano (IT)

(72) Inventor: Fabio Lettieri, Milano (IT)

(21) Appl. No.: 15/407,485

(22) Filed: Jan. 17, 2017

(30) Foreign Application Priority Data
Feb. 29, 2016 (IT) UB2016A001178

(51) Int. Cl. G08G 1/16; B60Q 9/00; B60R 1/00; H04W 4/00; B60R 11/04

(52) U.S. Cl. CPC G08G 1/168; H04W 4/008; B60R 11/04; B60R 1/002; B60Q 9/008; B60R 2011/004

(57) ABSTRACT

The driving assistance system of motor vehicles comprises a driving assistance device of a motor vehicle having at least a detection device for detecting the presence of possible obstacles on the outside of the motor vehicle, first activation/deactivation means operatively connected to the detection means and adapted to the activation/deactivation of the detection means, a first RF communication unit operatively connected to the first activation/deactivation means, removable fixing means of the assistance device to the motor vehicle, and wherein the system comprises a command device of the assistance device comprising an OBD type connector coupleable to an OBD type connection port of an on-board diagnostics system of the motor vehicle.

### BACKGROUND

Technical Field

The present invention relates to a driving assistance system of motor vehicles, particularly intended for a parking aid.

Background Art

Parking aid systems are known, fitted on board cars, and designed so as to warn the driver, by means of acoustic or visual signals, of the presence and the proximity of possible obstacles to parking maneuvers.

A first type of known system is that which employs ultrasonic proximity detectors, integrated in the front and/or rear bumpers.

The operation of this type of detector is based on the measurement of the reflection time of the sound pulses emitted and detected by it.

This system can be fitted in the motor vehicle during its manufacture, and therefore before purchase, or can be installed after purchase, using special kits marketed in the automotive aftermarket sector.

In this latter case, fitting the system requires the services of a skilled technician, who makes specific holes in the bumpers in order to obtain the housings for the detectors.

Furthermore, the detectors must necessarily be connected to the motor vehicle control unit to ensure that the system only operates when the reverse gear is engaged and to allow it to be powered by the motor vehicle battery itself.

This first type of known system has some drawbacks.

The main drawback is due to the fact that the system is based on the reflection of sound waves, which reduces its efficiency in detecting certain types of small obstacles or which are not flat including, e.g., a slim pole or an elongated object pointed towards the motor vehicle.

Since the detectors are fitted in the bumpers, it is evident that, in the case of rear-end collisions, these are very likely to be damaged.

Furthermore, the detectors are necessarily facing towards the outside of the motor vehicle and are therefore continuously exposed to atmospheric agents. This inevitably increases the possibility of failures and damage, making likely the need to replace the detectors before the end of the motor vehicle's life cycle, with consequent doubling of costs.

A second type of known system is based on the emission of radio waves and on the detection of the relative echoes coming from the obstacles present within their range of action.

Such second type of system, in practice, comprises sensors that use the same operating principle as the radar.

Such sensors are normally positioned at the inner surfaces of the bumpers and, therefore, even though their installation does not damage and does not modify the aesthetics of the bumpers, they do however have to be disassembled and reassembled by experienced personnel, which entails a certain time and cost expenditure.

This system too is connected, albeit indirectly, to the control unit, for power supply purposes.

A further significant drawback of this known system is that its operation is based on radio waves, something which can generate interference with other electromagnetic devices in the vicinity of the vehicle, thereby causing false positives or even harmful interference with the on-board electronics of the motor vehicle

A third type of known system is shown in the patent document WO 2014/111830, which describes a driving assistance device of motor vehicles provided with infrared means for the detection of the presence of possible obstacles outside of the motor vehicle and with a processing unit connected to the infrared means for the determination of the distance of the device from the obstacles detected by the infrared means themselves.

Furthermore, such a device comprises signaling means for signaling to the driver any obstacles present outside of the motor vehicle.

The device is associable with the rear window glass of any motor vehicle by means of suitable locking means without the need for skilled labor for relevant installation and without having to damage or disassemble parts of the motor vehicle body.

Such third type of known system is, however, susceptible to upgrading to improve operating reliability, simplicity and practical use by the driver of the motor vehicle.

### SUMMARY

The main aim of the present invention is to provide a driving assistance system of motor vehicles which is easily installable and usable by the driver and which upgrades the degree of reliability in detecting obstacles arranged outside of the motor vehicle, thus making the driver feel safer while performing parking maneuvers of the motor vehicle itself.

One object of the present invention is to provide a driving assistance system of motor vehicles which is installable on any model and make of motor vehicle and without the aid of skilled labor.

A further object of the present invention is to provide a driving assistance system of motor vehicles which has lower costs than known systems marketed in the aftermarket sector and which therefore arouses greater interest among consumers.

Another object of the present invention is to provide a driving assistance system of motor vehicles which allows to overcome the mentioned drawbacks of the prior art within the ambit of a simple, rational, easy, effective to use and affordable solution.

The above mentioned objects are achieved by the present driving assistance system of motor vehicles having the characteristics of claim 1.

### BRIEF DESCRIPTION OF THE DRAWINGS

Other characteristics and advantages of the present invention will become better evident from the description of a preferred, but not exclusive, embodiment of a driving assistance system of motor vehicles, illustrated by way of an indicative, but non-limiting, example in the accompanying drawings, wherein:

FIG. 1 is an axonometric view of the driving assistance system according to the invention;

FIG. 2 is an axonometric view of the command device of the system according to the invention;

FIG. 3 is an axonometric view from behind of the motor vehicle on which the system according to the invention is installed;

FIG. 4 is an axonometric view of a detail of the system according to the invention;

FIG. 5 is a front view of a detail of the system according to the invention in a coupling configuration;

FIG. 6 is a block diagram illustrating the operation of the system according to the invention.

### EMBODIMENTS OF THE INVENTION

With particular reference to such illustrations, globally indicated with reference numeral 1 is a driving assistance system of motor vehicles.

The system 1 comprises a driving assistance device 2 of a motor vehicle 3.

The assistance device 2 has at least a detection device 4, 5 for detecting the presence of possible obstacles on the outside of the motor vehicle 3, in more detail in the surrounding area of the motor vehicle itself.

The detection devices 4, 5 comprise acquisition means 4 of the images of the outside space surrounding the motor vehicle 3.

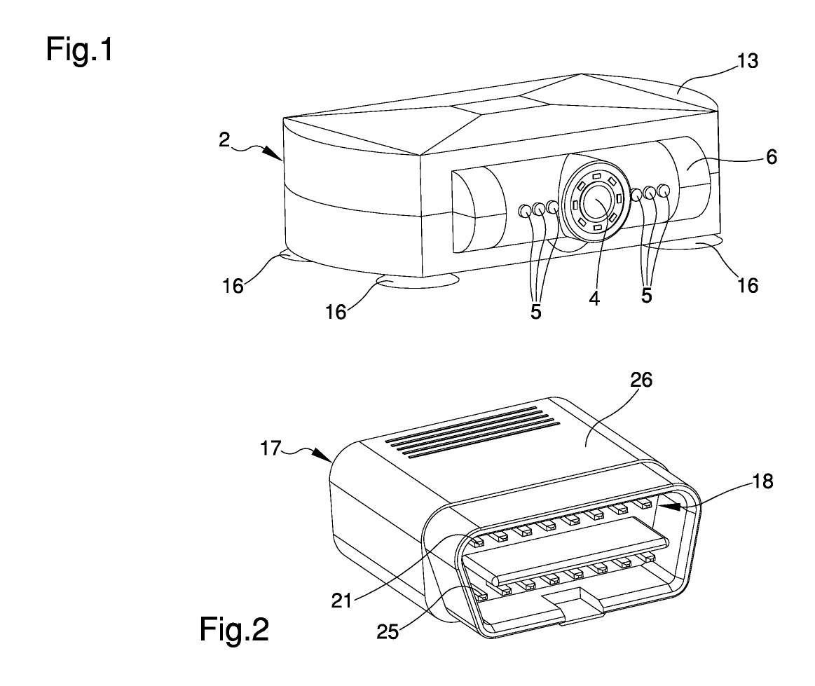

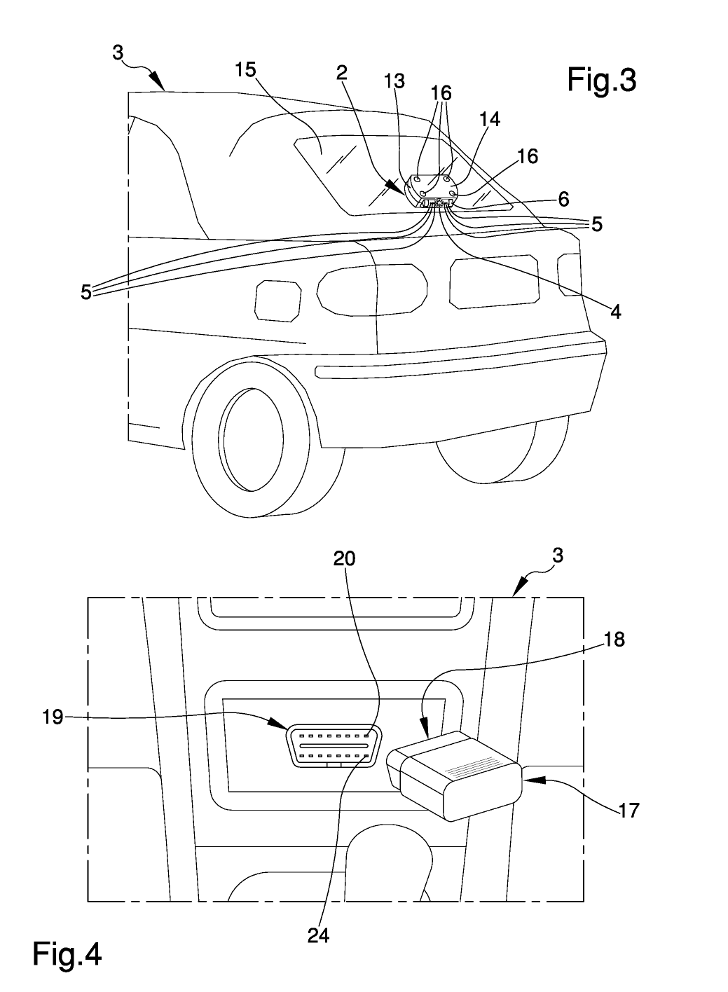

In the preferred embodiment shown in the FIGS. 1 and 3, the acquisition means 4 comprise a camera.

Alternative embodiments cannot however be ruled out in which the acquisition means 4 comprise a plurality of cameras.

The detection devices 4, 5 may also comprise at least a proximity sensor 5 having emitting means for emitting electromagnetic waves within a predefined space, variable according to the type of proximity sensor itself, and a detection device for detecting the electromagnetic waves reflected by the obstacles that are in the area within the range of action of the emitting means themselves.

It cannot however be ruled out that the assistance device 2 may comprise only the camera 4 for the acquisition of the images of the area surrounding the motor vehicle 3.

In the particular embodiment shown in the illustrations, the assistance device 2 has both the camera 4 and the proximity sensors 5.

The proximity sensor 5 is selected from infrared proximity sensors, ultrasonic proximity sensors, microwave proximity sensors and electromagnetic proximity sensors.

Preferably, the proximity sensor 5 chosen is an infrared proximity sensor in which the emitting means are of the type of infrared light radiation LED emitters.

As can be seen from FIGS. 1 and 3, the detection devices 4, 5 comprise a plurality of proximity sensors 5 adapted to define an area of sounding of the area behind the motor vehicle 3 in which the infrared radiation emitted by each proximity sensor 5 always points towards the ground, with a point of impact on the ground for example between 1 and 5 meters away from the motor vehicle 3.

With reference to the particular embodiment shown in the figures, the assistance device 2 comprises a supporting structure 6 adapted to support the camera 4 and the proximity sensors 5.

Preferably, the camera 4 and the proximity sensors 5 are arranged aligned along a direction of alignment.

Alternative embodiments cannot however be ruled out in which the camera 4 and the proximity sensors 5 are each associated with a respective supporting structure 6.

Usefully, the assistance device 2 comprises signaling means 7 operatively connected to the proximity sensors 5 and adapted to signal the presence of obstacles within a predetermined distance from the assistance device itself.

The signaling means 7 comprise a sound emission device which, once the presence of obstacles has been detected by means of the proximity sensors 5, emits an acoustic signal of variable intensity and/or length depending on the distance of the assistance device 2 from the obstacles, thus giving an alarm to the driver of the motor vehicle 3 during parking maneuvers.

Usefully, the assistance device 2 comprises a control unit 8, 9 of the detection devices 4, 5 and of the signaling means 7.

In more detail, the control unit 8, 9 comprises first processing means 8 of the images acquired by the acquisition means 4 adapted to obtain a video signal.

The first processing means 8 have a first software program adapted to process the signals acquired by the camera 4 to obtain the video signal.

The control unit 8, 9 also comprises second processing means 9 operatively connected to the proximity sensors 5 to determine the distance of the assistance device 2 from any obstacles arranged outside of the motor vehicle 3 and to obtain an obstacle identification signal.

Similarly to the first processing means 8, the second processing means 9 have a second software program adapted to process the signals acquired by the proximity sensors 5 to obtain the obstacle identification signal.

Usefully, the sound emission device 7 is operatively connected to the second processing means 9 for the emission of the acoustic signal relating to the obstacle identification signal provided by the second processing means themselves.

The assistance device 2 comprises first activation/deactivation means 10 operatively connected to the detection devices 4, 5 and adapted to activate/deactivate the detection devices themselves.

Furthermore, the assistance device 2 comprises first RF communication unit 11 operatively connected to the first activation/deactivation means 10 for the transmission of an activation/deactivation signal.

Usefully, the first RF communication unit 11 is also operatively connected to the first and second processing means 8, 9 for receiving the video signal and the obstacle identification signal, generated by the first and second processing means themselves, respectively.

In particular, the first RF communication unit 11 is operatively connectable to other devices having suitable RF communication modules which are adapted, e.g., to send enabling/disabling signals and to receive the video signal and the obstacle identification signal.

The first RF communication unit 11 is of the wireless type and is selected from Wi-Fi communication unit and Bluetooth communication unit.

Usefully, the assistance device 2 comprises a first rechargeable power supply unit 12 operatively connected to the detection devices 4, 5, the control unit 8, 9, the first activation/deactivation means 10, the signaling means 7 and the image acquisition means 4 to ensure the power supply and related operating autonomy.

The assistance device 2 comprises a first containment body 13, adapted to contain the supporting structure 6, in which are integrated the detection devices 4, 5, the signaling means 7, the control unit 8, 9, the first activation/deactivation means 10, the first RF communication unit 11 and the first power supply unit 12.

The first containment body 13 has a substantially parallelepiped shape and has a fixing surface 14 with a substantially planar profile.

Furthermore, the assistance device 2 comprises removable fixing means 16 of the assistance device itself to the motor vehicle 3.

According to a preferred embodiment, illustrated in the figures, the fixing means 16 allow the fixing of the assistance device 2 inside of the passenger compartment of the motor vehicle 3.

Different embodiments cannot however be ruled out in which, e.g., the fixing means 16 allow the fixing of the assistance device 2 outside of the motor vehicle 3. For example, the assistance device 2 can be fixed at or in proximity of the rear or front bumper of the motor vehicle 3.

These fixing means 16 are associated with the first containment body 13 and, more particularly, with the fixing surface 14.

In more detail, the fixing means 16 and the detection devices 4, 5 are arranged one with respect to the other so that when the assistance device 2 is fixed to the glass of the rear window 15 of the motor vehicle 3, then the detection devices 4, 5 are facing the glass for the detection of the obstacles.

For example, the fixing means 16 can be suction elements which allow the removable fixing of the assistance device 2 to the rear window 15 of the motor vehicle 3 in a position preferred by the driver of the motor vehicle itself.

It cannot be ruled out furthermore that the fixing means 16 be adhesive means, associated with the fixing surface 14, adapted to adhere to the glass of the rear window 15.

Usefully, the assistance device 2 comprises manual orientation means adapted to the variation in the orientation of the supporting structure 6 to ensure that, irrespective of the type of motor vehicle, of the inclination of the glass of the rear window 15 and of the position in which the assistance device 2 is fixed to the rear window 15 by means of the fixing means 16, the inclination of the infrared radiation emitted by the proximity sensors 5 is always optimal and irradiates the area of interest surrounding the motor vehicle 3.

In particular, the manual orientation means include a rotation shaft partially included within the first containment body 13 with respect to which it is rotatable around a relative axis of rotation.

Such orientation means comprise rotation means for causing the rotation of the rotation shaft, manually operable by the driver, by means of which it is possible to adjust the orientation of the infrared radiation incident onto the ground at the desired distance.

Alternative embodiments cannot however be ruled out in which the assistance device 2 comprises automatic orientation means of the supporting structure 6 depending on the inclination of the glass of the rear window 15 on which the assistance device itself is installed.

Usefully, the automatic orientation means comprise a calculation software for calculating the optimum inclination angle of the detection devices 4, 5 with respect to the ground.

This calculation software is operatively connected to a suitable inclination sensor adapted to detect the inclination of the glass of the rear window 15.

According to the invention, the system 1 comprises a command device 17 of the assistance device 2 comprising an OBD (On Board Diagnostic) type connector 18 coupleable to an OBD type connection port 19 of an on-board diagnostics system of the motor vehicle 3.

The connection port 19 and the connector 18 have first terminals 20, 21 respectively, operatively connectable to one another in a coupling configuration, in which the first terminal 20 of the connection port 19 is adapted to provide a running direction shift signal of the motor vehicle 3 and the first terminal 21 of the connector 18 is adapted to receive the running direction shift signal in the coupling configuration.

In the context of the present treatise, with the expression “running direction shift” is meant the switch from a first driving direction, in which the motor vehicle 3 moves forward, to a second driving direction, in which the motor vehicle reverses (in more common terms, it runs in reverse).

In other words, the moment the driver engages the reverse gear, the diagnostics system on board the motor vehicle 3 generates the running direction shift signal which is subsequently sent to the first terminal 20 of the connection port 19.

In the embodiment shown in the illustrations, the connection port 19 comprises a plurality of terminals of the female type, while the connector 18 comprises a plurality of terminals of the male type.

In the coupling configuration, the terminals of the connection port 19 are electrically connected to the terminals of the connector 18.

The command device 17 comprises a processing unit 22 operatively connected to the first terminal 21 of the connector 18 and adapted to obtain an activation/deactivation signal corresponding to the running direction shift signal, provided by the first terminal 20 of the connection port 19 in conjunction of the engagement of the reverse gear by the driver, in which the activation/deactivation signal is adapted to the activation/deactivation of the assistance device 2.

The processing unit 22 has a software program adapted to process the running direction shift signal, to obtain the activation/deactivation signal, variable according to the driving direction of the motor vehicle.

Usefully, the command device 17 comprises second RF communication unit 23 operatively connected to the first RF communication unit 11 for the transmission of the activation/deactivation signal to the first activation/deactivation means 10.

The processing unit 22 is operatively connected to the second RF communication unit 23 for the transfer of the activation/deactivation signal processed by the processing unit itself.

The second RF communication unit 23 is of the wireless type and is selected from Wi-Fi communication unit and Bluetooth communication unit.

The connector 18 and the connection port 19 comprise second terminals 24, 25 coupleable together in the coupling configuration.

In more detail, the second terminal 24 of the connection port 19 has a power supply signal provided by the on-board diagnostics system of the motor vehicle 3, while the second terminal 25 of the connector 18 is operatively connected to the second RF communication unit 23 for the provision of the power supply signal to the second RF communication unit itself.

Usefully, the second terminal 25 of the connector 18 is operatively connected to the processing unit 22 for the related power supply.

In the preferred embodiment shown in the figures, the command device 17 comprises a second containment body 26 adapted to contain the second RF communication unit 23 and the processing unit 22.

Preferably, the second containment body 26 is made of plastic material.

Advantageously, the system 1 comprises a display device 27 operatively connected to the image acquisition means 4 and having a display 28 for the display of the video signal by the driver.

Usefully, the display device 27 comprises a third RF communication unit 29 operatively connected to the second RF communication unit 23 for receiving the activation/deactivation signal from the command device 17, and to the first RF communication unit 11 for receiving the video signal from the first processing means 8.

The display device 27 also comprises processing means 30 of the video signal received by the third RF communication unit 29.

The processing means 30 are operatively connected to the display 28 for the real time display, by the driver, of the images acquired by the camera 4.

The display device 27 comprises second activation/deactivation means 31 operatively connected to the display 28 and to the processing means 30 for the activation/deactivation of the display 28 and of the processing means 30.

In more detail, the second activation/deactivation means 31 are operatively connected to the third RF communication unit 29 by means of which they receive the activation/deactivation signal by the second RF communication unit 23 in conjunction of the running direction shift of the motor vehicle 3.

Usefully, the display device 27 comprises a second rechargeable power supply unit 32 operatively connected to the display 28, to the second activation/deactivation means 31, to the third RF communication unit 29 and to the processing means 30.

Alternative embodiments cannot however be ruled out in which the display device 27 is of the type of a smartphone, or other similar devices, wherein by means of suitable dedicated software applications the display occurs of the video signal acquired by means of the camera 4 on the display device itself.

In the particular embodiment shown in the illustrations, the display device 27 comprises a third containment body 33 adapted to contain and support the display 28, the third RF communication unit 29, the second activation/deactivation means 31, the second power supply unit 32 and the processing means 30.

Usefully, the display device 27 comprises removable anchoring means 34 of the display device itself inside of the passenger compartment of the motor vehicle 3.

In particular, the anchoring means 34 are associated with the outer surface of the third containment body 33 and are adapted to the removable anchoring of the display device 27 to a portion of the surface of the dashboard or of the windshield glass depending on the preferences and needs of the driver of the motor vehicle 3.

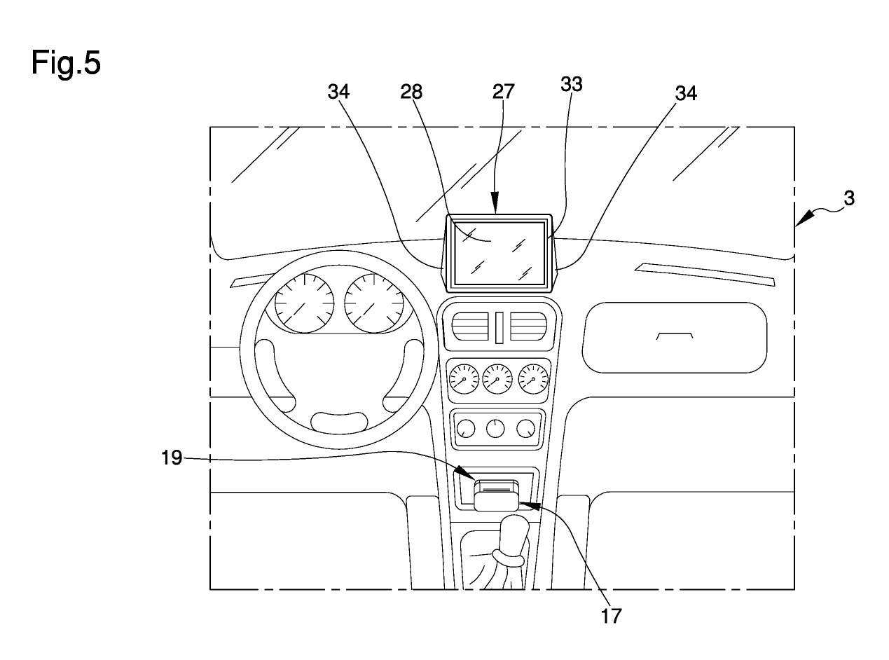

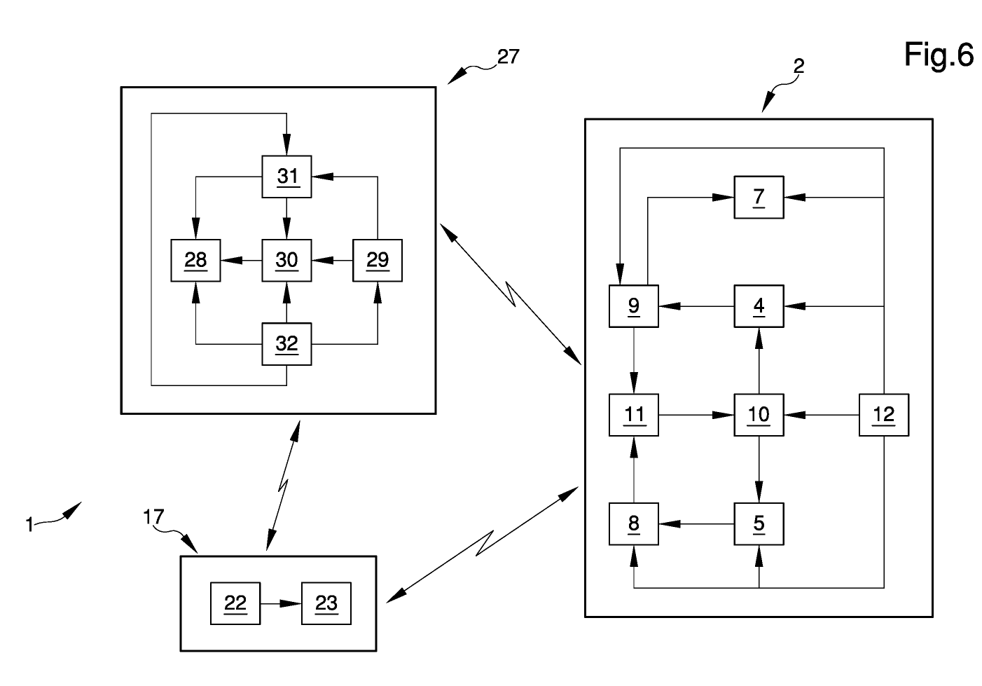

The operation of this invention is described below and is schematically represented in FIG. 5.

The driver of the motor vehicle 3 inserts the connector 18 of the command device 17 in the connection port 19 and, in the coupling configuration, the first terminal 21 of the connector 18 is coupled to the first terminal 20 of the connection port 19 while the second terminal 25 of the connector 18 is coupled to the second terminal 24 of the connection port 19.

Once, during driving, the driver engages the reverse gear, the first terminal 21 of the connector 18 receives the running direction shift signal from the first terminal 20 of the connection port 19 and in turn provided by the diagnostics system on board the motor vehicle 3.

Such a running direction shift signal is acquired by the processing unit 22, operatively connected to the first terminal 21 of the connector 18, which processes the activation/deactivation signal and provides it to the second RF communication unit 23 operatively connected to it.

The second RF communication unit 23 sends the activation/deactivation signal to the first RF communication unit 11 which, being operatively connected to the first activation/deactivation means 10, activate the detection devices 4, 5.

In more detail, the proximity sensors 5 provide measurements on the distance of the assistance device 2 from the potential obstacles surrounding the motor vehicle 3, and such measurements are collected by the control unit 8, 9.

Even in more detail, the first processing means 8 generate obstacle identification signals which are sent to the signaling means 7, which provide acoustic signals having variable length and/or intensity depending on the distance between any obstacles surrounding the motor vehicle 3 and the assistance device 2.

At the same time, the camera 4 picks up the images of the area surrounding the motor vehicle 3, which are then supplied to the first processing means 8 for the processing of the relevant video signal.

In conjunction with the sending of the activation/deactivation signal from the second RF communication unit 23 to the first RF communication unit 11, the second RF communication unit 23 sends the same activation/deactivation signal to the third RF communication unit 29.

The third RF communication unit 29 sends the activation/deactivation signal to the second activation/deactivation means 31 to start the display 28 and the processing means 30.

The third RF communication unit 29 receives the video signal from the second RF communication unit 23, which in turn is processed by the processing means 30 to obtain real time images acquired by the camera 4, which are then displayed by the driver by means of the display 28.

It has in fact been ascertained that the described invention achieves the intended objects and, in particular, the fact is underlined that the driving assistance system of motor vehicles made this way is easily installable and usable by the driver and, by means of the combination of proximity sensors and the camera, has a high degree of reliability in detecting obstacles arranged outside of the motor vehicle.

The particular alternative embodiment shown in the description, but not shown in the illustrations, in which the system is provided only with the acquisition means of the images of the area surrounding the motor vehicle, allows the driver to monitor in real time the space surrounding the motor vehicle during reversing maneuvers and provides greater peace of mind and reliability to the driver during such maneuvers.

Moreover, such system has lower costs than systems known on the market and is very simple and practical to install and use on any motor vehicle and without the aid of skilled labor.

1. A driving assistance system of motor vehicles, comprising at least a driving assistance device of a motor vehicle having:
at least a detection device for detecting the presence of possible obstacles on the outside of said motor vehicle;
first activation/deactivation means operatively connected to said detection device and adapted to the activation/deactivation of said detection device;
at least a first RF communication unit operatively connected to said first activation/deactivation means;
removable fixing means of said assistance device to said motor vehicle;
at least a command device of said assistance device comprising at least an OBD type connector coupleable to an OBD type connection port of an on-board diagnostics system of said motor vehicle, said connection port and said connector having first terminals operatively connectable to one another in a coupling configuration, said first terminal of said connection port being adapted to provide a running direction shift signal of said motor vehicle, said first terminal of said connector being adapted to receive said running direction shift signal in said coupling configuration, said command device comprising:
at least a processing unit operatively connected to said first terminal of said connector and adapted to obtain at least an activation/deactivation signal corresponding to said running direction shift signal and adapted to the activation/deactivation of said assistance device;
at least a second RF communication unit operatively connected to said first RF communication unit for the transmission of said activation/deactivation signal to said first activation/deactivation means.

2. The system according to claim 1, wherein said detection device comprises acquisition means of images of the outside space surrounding said motor vehicle.

3. The system according to claim 2, wherein said acquisition means comprise at least a camera.

4. The system according to claim 1, wherein said detection device comprise at least a proximity sensor.

5. The system according to claim 4, wherein said at least a proximity sensor is selected from infrared proximity sensors, ultrasonic proximity sensors, microwave proximity sensors and electromagnetic proximity sensors.

6. The system according to claim 4, wherein said assistance device comprises signaling means operatively connected to said at least a proximity sensor and adapted to signal the presence of obstacles within a predetermined distance from said assistance device.

7. The system according to claim 6, wherein said assistance device comprises at least a first rechargeable power supply unit operatively connected to said detection device, control unit, first activation/deactivation means, signaling means and acquisition means.

8. The system according to claim 6, wherein said assistance device comprises at least a control unit of said detection device and said signaling means.

9. The system according to claim 1, wherein said connector and said connection port comprise second terminals coupleable together in said coupling configuration, said second terminal of said connection port having a power supply signal provided by the on-board diagnostics system of said motor vehicle, said second terminal of said connector being operatively connected to said second RF communication unit for the provision of said power supply signal to said second RF communication unit.

10. The system according to claim 1, wherein said fixing means and said detection device are arranged one with respect to the other so that said assistance device is fixed to the glass of the rear window of said motor vehicle and said detection device are facing the glass of the rear window for the detection of obstacles.

11. The system according to claim 8, wherein said control unit comprises first processing means of the images acquired by said acquisition means of images adapted to obtain a video signal.

12. The system according to claim 11, wherein said control unit comprises second processing means operatively connected to said at least a proximity sensor for the determination of the distance of said assistance device from the obstacles.

13. The system according to claim 11, wherein said signaling means comprise at least a sound emission device operatively connected to said first processing means.

14. The system according to claim 1, comprising at least a display device operatively connected to said acquisition means and comprising at least a display for displaying said video signal.

15. The system according to claim 14, wherein said display device comprises at least a third RF communication unit operatively connected to said second RF communication unit for receiving said activation/deactivation signal from said command device and to said first RF communication unit for receiving said video signal from said assistance device.

16. The system according to claim 15, wherein said display device comprises processing means of said video signal received by said second RF communication unit, said processing means being operatively connected to said display.

17. The system according to claim 16, wherein said display device comprises second activation/deactivation means operatively connected to said display and to said processing means for the activation/deactivation of said display and of said processing means, said second activation/deactivation means being operatively connected to said third RF communication unit.

18. The system according to claim 17, wherein said display device comprises at least a second rechargeable power supply unit operatively connected to said display, second activation/deactivation means, processing means and said third RF communication unit.

19. The system according to claim 14, wherein said display device comprises removable anchoring means of said display device inside of the passenger compartment of said motor vehicle.
